(19) United States
(12) Patent Application Publication
(10) Pub. No.: US 2026/0003750 A1
(43) Pub. Date: Jan. 1, 2026

(54) METHOD, DEVICE, AND COMPUTER PROGRAM PRODUCT FOR SYNCHRONIZING DATA

(71) Applicant: Dell Products L.P., Round Rock, TX (US)

(72) Inventors: Jie Huang, Chengdu (CN); Xingxin Li, Chengdu (CN); Guoping Guan, Chengdu (CN)

(21) Appl. No.: 19/004,734

(22) Filed: Dec. 30, 2024

(30) Foreign Application Priority Data
Jun. 27, 2024 (CN) 202410850742.7

(51) Int. Cl. G06F 11/20; G06F 11/14

(52) U.S. Cl. CPC G06F 11/2082; G06F 11/1464

(57) ABSTRACT

Techniques for synchronizing data involve determining, in response to that a replication session in a source cluster is initiated, a recovery point objective (RPO) of the replication session and a plurality of parameters of each device in a plurality of devices in a remote cluster. The plurality of parameters include at least performance headroom and a recovery point objective of a resident replication session. Such techniques further involve selecting a target device from the plurality of devices based on the recovery point objective of the replication session and the plurality of parameters. Such techniques further involve synchronizing data associated with the replication session from the source cluster to the target device in the remote cluster. Accordingly, replication sessions can be evenly distributed across devices, thereby improving resource utilization and data synchronization efficiency, preventing depletion of device utilization, reducing RPO bias, and strengthening the protection for disaster recovery data.

### CROSS-REFERENCE TO RELATED APPLICATION

This application claims priority to Chinese Patent Application No. CN202410850742.7, on file at the China National Intellectual Property Administration (CNIPA), having a filing date of Jun. 27, 2024, and having “METHOD, DEVICE, AND COMPUTER PROGRAM PRODUCT FOR SYNCHRONIZING DATA” as a title, the contents and teachings of which are herein incorporated by reference in their entirety.

### TECHNICAL FIELD

The present disclosure relates to the field of data management, and more specifically, to a method, device, and computer program product for synchronizing data.

### BACKGROUND

When a disaster occurs, the data synchronization technology can ensure timely backup and recovery of data, thereby protecting the data from loss. Data synchronization typically involves collaboration between a source cluster and a remote cluster. The source cluster is responsible for creating, allocating, and protecting data, and the remote cluster is responsible for receiving and storing data. By creating and allocating volumes, defining protection strategies, and creating replication sessions, the data synchronization technology ensures real-time and consistent data between the source cluster and the remote cluster.

In a data synchronization process, the remote cluster selects a device in the remote cluster according to a preset rule and creates a target volume on the selected device to store data associated with a replication session. When a replication session is initiated in the source cluster, the system starts synchronizing data associated with the replication session in the target volume, ensuring that the data in the target volume is synchronized with the source cluster, thereby ensuring the integrity of the data when a disaster occurs.

### SUMMARY OF THE INVENTION

Embodiments of the present disclosure propose a method, device, and computer program product for synchronizing data.

In a first aspect of the embodiments of the present disclosure, a method for synchronizing data is provided. The method includes determining, in response to that a replication session in a source cluster is initiated, a recovery point objective of the replication session and a plurality of parameters of each device in a plurality of devices in a remote cluster, the plurality of parameters including at least performance headroom and a recovery point objective of a resident replication session. The method further includes selecting a target device from the plurality of devices based on the recovery point objective of the replication session and the plurality of parameters. The method further includes synchronizing data associated with the replication session from the source cluster to the target device in the remote cluster.

In a second aspect of the embodiments of the present disclosure, an electronic device is provided. The electronic device includes one or a plurality of processors; and a storage apparatus for storing one or a plurality of programs, wherein the one or a plurality of programs, when executed by the one or a plurality of processors, cause the one or a plurality of processors to implement a method for synchronizing data. The method includes determining, in response to that a replication session in a source cluster is initiated, a recovery point objective of the replication session and a plurality of parameters of each device in a plurality of devices in a remote cluster, the plurality of parameters including at least performance headroom and a recovery point objective of a resident replication session. The method further includes selecting a target device from the plurality of devices based on the recovery point objective of the replication session and the plurality of parameters. The method further includes synchronizing data associated with the replication session from the source cluster to the target device in the remote cluster.

In a third aspect of the embodiments of the present disclosure, a computer-readable storage medium is provided on which a computer program is stored, wherein the program, when executed by a processor, implements a method for synchronizing data. The method includes determining, in response to that a replication session in a source cluster is initiated, a recovery point objective of the replication session and a plurality of parameters of each device in a plurality of devices in a remote cluster, the plurality of parameters including at least performance headroom and a recovery point objective of a resident replication session. The method further includes selecting a target device from the plurality of devices based on the recovery point objective of the replication session and the plurality of parameters. The method further includes synchronizing data associated with the replication session from the source cluster to the target device in the remote cluster.

It should be understood that the content described in the Summary of the Invention part is neither intended to limit key or essential features of the embodiments of the present disclosure, nor intended to limit the scope of the present disclosure. Other features of the present disclosure will become readily understood from the following description.

### BRIEF DESCRIPTION OF THE DRAWINGS

The above and other features, advantages, and aspects of the embodiments of the present disclosure will become more apparent with reference to the accompanying drawings and the following detailed description. In the accompanying drawings, identical or similar reference numerals represent identical or similar elements, in which

FIG. 1 shows a schematic diagram of an example environment in which a plurality of embodiments of the present disclosure can be implemented;

FIG. 2 shows a flow chart of a method for synchronizing data according to some embodiments of the present disclosure;

FIG. 3 shows a flow chart of a process for selecting a target device according to some embodiments of the present disclosure;

FIG. 4 shows a schematic diagram of a global process of synchronizing data according to some embodiments of the present disclosure;

FIG. 5A shows a schematic diagram of a variance of the numbers of volumes of various devices in a remote cluster according to some embodiments of the present disclosure;

FIG. 5B shows a schematic diagram of a variance of capacities of various devices in a remote cluster according to some embodiments of the present disclosure;

FIG. 5C shows a schematic diagram of a variance of performance headroom of various devices in a remote cluster according to some embodiments of the present disclosure;

FIG. 5D shows a schematic diagram of a variance of the numbers of replication sessions with the same recovery point objective (RPO) in various devices in a remote cluster according to some embodiments of the present disclosure;

FIG. 6A shows a schematic diagram of a graphical user interface for distribution of numbers of volumes in various devices of a remote cluster in related technologies;

FIG. 6B shows a schematic diagram of a graphical user interface for distribution of numbers of volumes in various devices of a remote cluster according to some embodiments of the present disclosure;

FIG. 6C shows an interface diagram of a graphical user interface for the number of replication sessions that miss RPO in a data synchronization process in related technologies;

FIG. 6D shows an interface diagram of a graphical user interface for the number of replication sessions that miss RPO in a data synchronization process according to some embodiments of the present disclosure; and

FIG. 7 is a block diagram of a device that can implement a plurality of embodiments of the present disclosure.

### DETAILED DESCRIPTION

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

It should be understood that the specialized circuitry that performs one or more of the various operations disclosed herein may be formed by one or more processors operating in accordance with specialized instructions persistently stored in memory. Such components may be arranged in a variety of ways such as tightly coupled with each other (e.g., where the components electronically communicate over a computer bus), distributed among different locations (e.g., where the components electronically communicate over a computer network), combinations thereof, and so on.

The embodiments of the present disclosure will be described below in further detail with reference to the accompanying drawings. Although the accompanying drawings show some embodiments of the present disclosure, it should be understood that the present disclosure may be implemented in various forms, and should not be explained as being limited to the embodiments stated herein. Rather, these embodiments are provided for understanding the present disclosure more thoroughly and completely.

It should be understood that the accompanying drawings and embodiments of the present disclosure are for illustrative purposes only, and are not intended to limit the scope of protection of the present disclosure.

In the description of the embodiments of the present disclosure, the term “include” and similar terms thereof should be understood as open-ended inclusion, that is, “including but not limited to.”

The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

In a process of data synchronization, a remote cluster usually stores, by setting up volumes, data synchronized from a source end. In related technologies, the location allocation of a target volume in a remote cluster system mainly depends on the capacity of a target device. However, this allocation strategy often overlooks the current performance and actual load situation of the device. Due to the limited maximum number of replication sessions running simultaneously on the same device, this single-dimensional allocation method may cause some devices to be overloaded due to excessive load for a long time, thereby affecting their efficiency in handling replication tasks and even having a negative impact on the performance of the entire cluster. Especially when a failure occurs, the source cluster and the remote cluster may switch. If replication sessions are concentrated on a single device, the excessive workload may prolong the switching time, leading to excessively long downtime and further exacerbating the instability and performance degradation of the cluster.

In addition, the target volume allocation scheme that only considers device capacity lacks effective differentiation and priority management when dealing with replication requirements of different types and intensities. This leads to the possibility that replication sessions with the same RPO may be concentrated and distributed to one or several remote devices during replication session allocation. Especially during failover or when cluster activities increase, this uneven distribution of replication sessions will further exacerbate the load pressure on certain devices, leading to problems such as queuing replication tasks and missing RPO. This not only affects the efficiency and quality of data replication, but may also have adverse effects on the stability and performance of the entire cluster.

To this end, the embodiments of the present disclosure provide a solution for synchronizing data. The solution selects a target device according to a recovery point objective of a replication session in a source cluster and a plurality of parameters of each device in a remote cluster, and then synchronizes data associated with the replication session from the source cluster to a target cluster on the selected target device. The plurality of parameters include at least performance headroom of the device and a recovery point objective of a resident replication session in the device. In this way, taking into account a plurality of parameters such as the RPO and the performance headroom when allocating replication sessions, the replication sessions can be evenly allocated across a plurality of devices, avoiding the situation where all replication sessions are concentrated on a single device. Additionally, replication sessions with the same RPO can be distributed across a plurality of different devices, thereby improving the device resource utilization and the data synchronization efficiency, preventing depletion of device utilization, reducing RPO bias, and thus strengthening the protection for disaster recovery data.

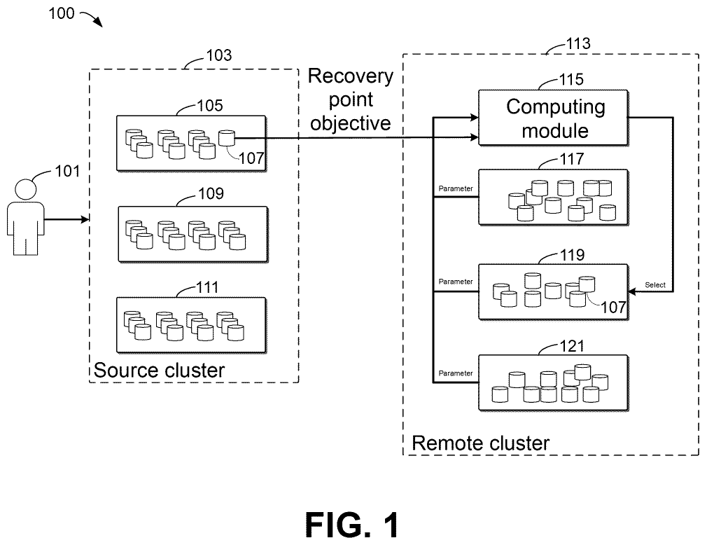

FIG. 1 shows a schematic diagram of an example environment 100 in which a plurality of embodiments of the present disclosure can be implemented. As shown in FIG. 1, the example environment 100 may include a source cluster 103, and the source cluster 103 may be a system for centralized storage and management of data. A user 101 may read and write data on devices of the source cluster 103. The source cluster 103 may include a device 105, a device 109, and a device 111, and the devices may be storage devices. The number and configuration of the devices may be selected and adjusted according to actual needs to meet different storage needs. The devices in the source cluster 103 include a plurality of volumes for storing data, and the volumes are storage units. The user 101 may choose locations to create volumes, and the source cluster 103 may also automatically create volumes for the user 101, thereby allocating and managing storage space according to preset rules and strategics.

As shown in FIG. 1, the example environment 100 may include a remote cluster 113, and the remote cluster 113 may be a distributed storage system or data center geographically away from the source cluster 103. The remote cluster 113 may improve the data availability and disaster recovery capability or meet specific needs through geographic dispersion. The remote cluster 113 may include a device 117, a device 119, and a device 121, and the devices may be storage devices. A plurality of devices are used for storing data synchronized from the source cluster 103 to provide storage services with high availability and scalability. When there is data in the source cluster 103 that needs to be synchronized to the remote cluster 113, the source cluster 103 may initiate a replication session. The remote cluster 113 selects a target device based on a preset strategy, creates a target volume on the target device, and finally synchronizes data associated with the replication session on the target volume.

In some embodiments, the remote cluster 113 may include a computing module 115, and the computing module 115 may be a storage device capable of selecting a target device according to a preset strategy. In the embodiment of the present disclosure, the computing module 115 may select the target device based on an RPO of a replication session in the source cluster 103 and a plurality of parameters of each device in the remote cluster 113, and the plurality of parameters at least include an RPO of a resident replication session on each device and performance headroom of each device. For example, when a replication session is initiated in the source cluster 103, the computing module 115 may acquire the RPO of the replication session in the source cluster 103 and the RPO of a resident replication session in each device in the remote cluster 113. A target device is selected according to the RPO of the replication session in the source cluster 103 and the RPO of the resident replication session in each device, such that replication sessions with the same RPO in the remote cluster 113 may be evenly distributed across different devices.

In some embodiments, the computing module 115 may further acquire a plurality of parameters of each device in the remote cluster 113, such as central processing unit (CPU) utilization, memory utilization, disk I/O, load condition, network bandwidth and latency, or the like, which may be specifically selected according to actual needs. The computing module 115 may calculate current performance headroom of each device according to hardware configuration of each device. When a replication session is initiated in the source cluster 101, the target device may also be selected according to the performance headroom. For example, if a replication session in a volume 107 is initiated and the device 119 has the highest performance headroom among the device 117, the device 119, and the device 121, a target volume 107 may be created on the device 119 to synchronize the data associated with the replication session.

According to the embodiments of the present disclosure, a target device is selected according to a recovery point objective of a replication session in a source cluster and a plurality of parameters of each device in a remote cluster, and then data associated with the replication session is synchronized from the source cluster to a target cluster on the selected target device. The plurality of parameters include at least performance headroom of the device and a recovery point objective of a resident replication session in the device. Through this method, replication sessions with the same RPO requirements may be dispersed to a plurality of different devices, thereby reducing the number of replication sessions that miss RPO, improving the device resource utilization and data synchronization efficiency, effectively preventing the depletion of device utilization, and strengthening the disaster recovery data protection capability.

It should be understood that the architecture and functions in the example environment 100 are described for example purposes only, without implying any limitation to the scope of the present disclosure. The embodiments of the present disclosure may also be applied to other environments having different structures and/or functions.

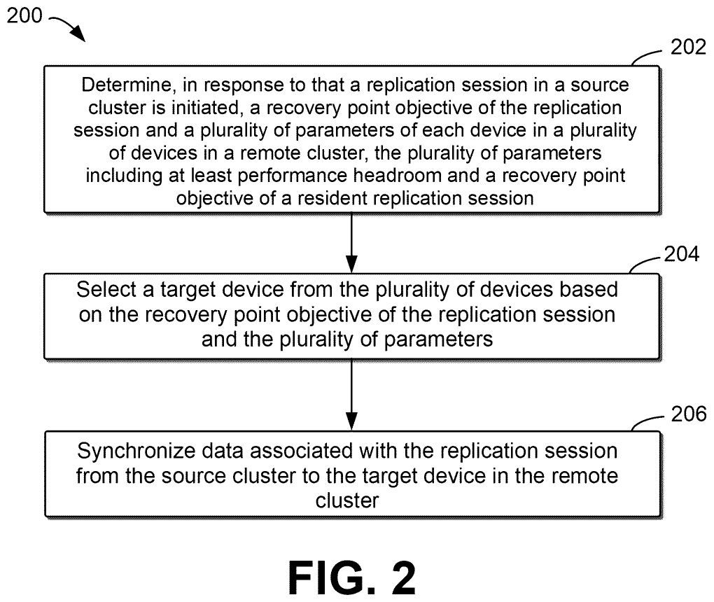

A process of the embodiment of the present disclosure will be described in detail below with reference to FIG. 2 to FIG. 6D. For case of understanding, the specific data mentioned in the following description are all illustrative and are not intended to limit the scope of protection of the present disclosure. It should be understood that the embodiments described below may also include additional actions not shown and/or may omit actions shown, and the scope of the present disclosure is not limited in this regard.

FIG. 2 shows a flow chart of a method 200 for synchronizing data according to some embodiments of the present disclosure. At a block 202, in response to that a replication session in a source cluster is initiated, a recovery point objective of the replication session and a plurality of parameters of each device in a plurality of devices in a remote cluster are determined, the plurality of parameters including at least performance headroom and a recovery point objective of a resident replication session. For example, as shown in FIG. 1, when a replication session is initiated in the source cluster 103, the computing module 115 may obtain the RPO of the replication session in the source cluster 103 and the plurality of parameters of each device in the remote cluster 113, such as CPU utilization, memory utilization, disk I/O, load condition, network bandwidth and latency, or the like, which may be specifically selected according to actual needs. The plurality of parameters include at least the RPO of the resident replication session and the performance headroom of each device in the remote cluster 113. The computing module 115 may calculate current performance headroom of each device according to hardware configuration of each device.

At a block 204, a target device is selected from the plurality of devices based on the recovery point objective of the replication session and the plurality of parameters. For example, as shown in FIG. 1, when a replication session is initiated in the source cluster 103, the computing module 115 may select the target device according to the RPO of the replication session in the source cluster 103 and the RPO of the resident replication session in each device, so that the RPO of the replication session on each device in the remote cluster 113 is as different as possible, that is, replication sessions with the same RPO are caused to be evenly distributed on different devices. The computing module 115 may also select the target device according to the performance headroom or other parameters. For example, if a replication session in a volume 107 is initiated and the device 119 has the highest performance headroom among the device 117, the device 119, and the device 121, a target volume 107 may be created on the device 119 to synchronize the data associated with the replication session.

At a block 206, data associated with the replication session is synchronized from the source cluster to the target device in the remote cluster. For example, as shown in FIG. 1, after the target device is selected in the remote cluster 113, a target volume is created on the target device, and the target volume is a storage unit prepared for storing synchronized data to ensure data integrity and isolation. After the data associated with the replication session is transmitted to the target device, the remote cluster 113 may write the data to the created target volume and synchronize the data associated with the replication session on the target volume.

Through this method, replication sessions with the same RPO requirements may be dispersed to a plurality of different devices, thereby reducing the number of replication sessions that miss RPO, improving the device resource utilization and data synchronization efficiency, effectively preventing the depletion of device utilization, and strengthening the disaster recovery data protection capability. In addition, a process of switching from the remote cluster to the source cluster may be accelerated when a failover occurs, thereby minimizing the downtime.

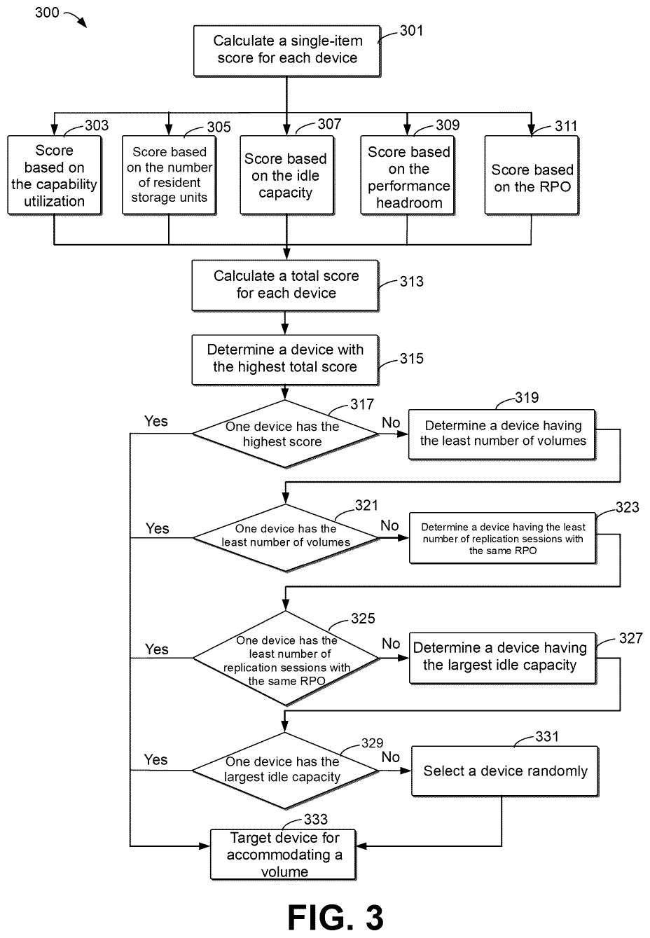

The example process of generating a retention strategy will be specifically described below with reference to FIG. 3 to FIG. 7. In the embodiment of the present disclosure, explanations are provided in the order of selecting the target device, the global process of synchronizing data, the variance of various parameters between devices after the implementation of the solution of the present disclosure, and comparing the effectiveness of the solution of the present disclosure after implementation with that of related technologies. The specific data mentioned in the following description are all illustrative and are not intended to limit the scope of protection of the present disclosure. It should be understood that the embodiments described below may also include additional actions not shown and/or may omit actions shown, and the scope of the present disclosure is not limited in this regard.

FIG. 3 shows a schematic diagram of a process 300 for selecting a target device according to some embodiments of the present disclosure. In some embodiments, after determining the RPO of the replication session in the source cluster and a plurality of parameters of each device in the remote cluster, a score for each device may be determined according to the RPO of the replication session and the plurality of parameters, and then a target device may be selected from a plurality of devices according to the score for each device. As shown in FIG. 3, at a block 301, the score for each device is calculated. The score for each device may be calculated according to the RPO of the replication session and a plurality of parameters. In the embodiment of the present disclosure, the plurality of parameters may include capacity utilization, number of resident storage units, idle capacity, performance headroom, and RPO of the resident replication session. Of course, during specific implementation, parameters may be randomly selected from the above parameters, or other types of parameters may be selected, such as network bandwidth and delay, device type, device compatibility rate, or power energy efficiency, which may be selected according to actual needs.

At a block 303, a score for each device (also referred to as a first score) is determined according to the capacity utilization. The capacity utilization of the device may be determined by calculating a ratio of the used capacity to the total capacity:

$$if {ApplianceCapacity}_{used} + {Capacity}_{voli} > {ApplicanceCapacity}_{total} * HighWatermark , \qquad ( 1 )$$

$$S {1}_{ij} = 0 , otherwise , S {1}_{ij} = 1$$

wherein ApplianceCapacity_{used} represents the total capacity of the device j, Capacityᵥₒₗᵢ represents the capacity of the target volume volᵢ, ApplianceCapacityₜₒₜₐₗ represents the used capacity of the device j, HighWatermark represents the high watermark of the capacity of the device j, and S1ᵢⱼ represents the score for the device j based on the capacity utilization. When a ratio of the sum of the capacity ApplianceCapacityₜₒₜₐₗ used by the device j and the capacity of the target volume volᵢ to be placed on the device j to the total capacity ApplianceCapacity_{used} of the device j exceeds the high watermark HighWatermark of the capacity of the device j, it indicates that the device j has reached a high utilization, and a low target volume volᵢ placement priority may be set for the device j, and at this point, it is determined that a score S1ᵢⱼ for the device j based on the capacity utilization is 0. When the ratio of the sum of the capacity ApplianceCapacitytotal used by the device j and the capacity of the target volume volᵢ to be placed on the device j to the total capacity ApplianceCapacityused of the device j does not exceed the high watermark HighWatermark of the capacity of the device j, it is determined that the score S1ᵢⱼ for the device j based on the capacity utilization is 1.

At a block 305, a score for each device (also referred to as a second score) is determined based on the resident storage unit. In some embodiments, a score may be determined for each device according to the number of existing volumes on the device, volumes in the same volume group will be considered as one volume, and devices with more existing volumes score lower. For example, all devices may be sorted in descending order of the number of volumes, and the devices may be scored according to serial numbers of the sorting order. The score for the jth device is the jth power of 2. Devices with the same sorting serial number will have the same score.

At a block 307, a score for each device (also referred to as a third score) is determined according to the idle capacity. Before placing a volume on a device, the remaining capacity of each device is determined. In some embodiments, the remaining capacities of all devices may be sorted in ascending order. The device with the least remaining capacity receives the lowest score of 1, and other devices are scored in the order of ranking. The scores for other devices will sequentially increase according to the sorting order of their remaining capacities. Devices with the same remaining capacity will obtain the same score.

At a block 309, a score for each device (also referred to as a fourth score) is determined according to the performance headroom. When selecting a device, scoring can also be based on the consumption of performance headroom of the device. The performance headroom of the device is limited by software or hardware components and may be determined according to actual parameters of the device, such as idle states of the CPU (central processing unit), back-end disks, and front-end ports. A higher comprehensive evaluation of these indicators indicates that the system processes a stronger business carrying capacity. Therefore, when a new volume is placed, a device with a high comprehensive evaluation score, that is, large performance headroom may be selected preferably to ensure the efficient and stable operation of the system. In some embodiments, a value range based on the performance headroom may be from 0 to 100, wherein 0 indicates that the system resources are fully saturated, and 100 indicates that the system is completely idle and not carrying any load. The workload intensity of each volume may directly affect the performance headroom of the device after placement. If the workload of a certain volume results in more significant resource consumption of the device compared to other devices, placing the volume on the device may not be the best choice, and in this case, the device will obtain a low score when scoring.

At a block 311, according to the RPO of the replication session of the source cluster and the RPO of each replication session in each device, a score for each device (also known as a fifth score) is determined. Due to the limited maximum number of replication sessions running simultaneously on the same device, distributing replication sessions with the same RPO evenly across different devices can improve the efficiency of data synchronization. When scoring, the more the resident replication sessions on the device that have the same RPO as the replication session in the source cluster, the lower the score. Conversely, the fewer the resident replication sessions on the device that have the same RPO as the replication session in the source cluster, the higher the score.

At a block 313, a total score for each device is calculated. In some embodiments, the total score for each device may be calculated according to the following formula:

$${S}_{ij} = S {1}_{ij} * S {2}_{ij} * S {3}_{ij} * S {4}_{ij} * S {5}_{ij} , j = 1 , 2 , … , N , N ∈ \{ 2 , 3 , 4 \} \qquad ( 2 )$$

wherein Sᵢⱼ represents the total score for the device j, S1ᵢⱼ represents the score for the device j based on the capacity utilization, S2ᵢⱼ represents the score for the device j based on the number of the resident storage units, S3ᵢⱼ represents the score for the device j based on the idle capacity, S4ᵢⱼrepresents the score for the device j based on the performance headroom, S5ᵢⱼ represents the score for the device j based on the RPO, and N represents the number of devices in the remote cluster.

At a block 315, it is determined whether there is only one device with the highest total score. In some embodiments, the device with the highest total score may be determined according to the following formula.

$${S}_{ik} = max ( {S}_{i 1} , {S}_{i 2} , … , {S}_{iN} ) \qquad ( 3 )$$

wherein Sᵢₖ represents the highest score, and therefore, it may be determined that the device with the highest total score is the kth device.

At a block 317, it is determined whether there is only one device with the highest score. When there is only one device with the highest total score, the device with the highest score is determined as the target device. When there are a plurality of devices with the same total score and all have the highest score, a block 319 is performed to determine the device with the least number of volumes among the devices with the highest score.

At a block 321, it is determined whether there is only one device with the least number of volumes. When there is only one device with the least number of volumes, the device with the least number of volumes is determined as the target device. When there are a plurality of devices with the same total score, all of which have the highest score and the same number of volumes, a block 323 is performed to determine the device with the least number of resident replication sessions with the same RPO, that is, determine the device with the least number of resident replications with the same RPO as that of the replication session in the source cluster.

At a block 325, it is determined whether there is only one device with the least number of resident replication sessions with the same RPO. When there is only one device with the least number of resident replication sessions with the same RPO, the device is determined as the target device. When there are a plurality of devices with the least number of resident replication sessions with the same RPO, a block 327 is performed to determine the device having the largest idle capacity.

At a block 329, it is determined whether there is only one device with the largest idle capacity. When there is only one device with the largest idle capacity, the device is determined as the target device. When there are a plurality of devices with the largest idle capacity, a block 331 is performed, wherein one device is selected randomly to serve as a target device 333 for accommodating the volume.

In some embodiments, the determination conditions for selecting the target device mentioned above may also be rearranged or other conditions may be used according to actual needs, with the specific purpose of selecting the optimal target device being met. Through this method, volumes can be allocated more reasonably, and overload of a specific device can be avoided, thereby optimizing the resource allocation, and improving the performance of the entire cluster. In addition, by distinguishing replication sessions of different intensities and types, high-load replications can be prevented from being concentrated on a single device, thereby reducing the device pressure, ensuring the system reliability and stability, reducing the fault recovery time, and improving the system scalability.

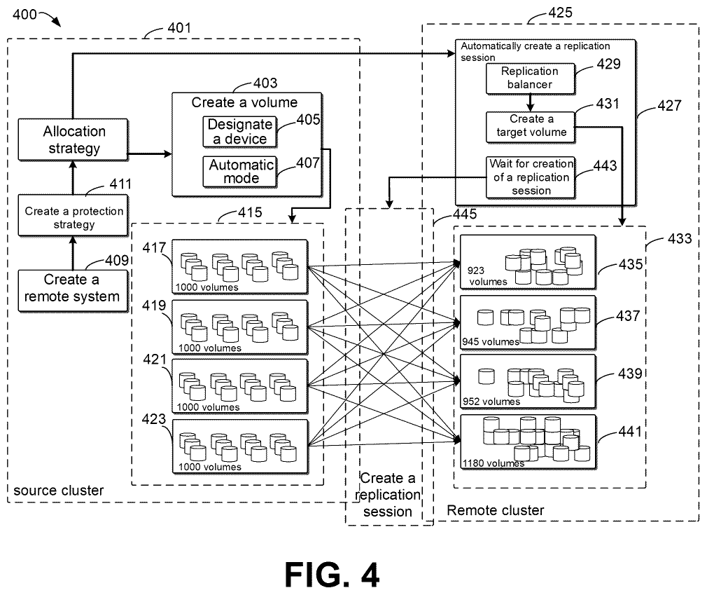

FIG. 4 shows a schematic diagram of a global process 400 of synchronizing data according to some embodiments of the present disclosure. As shown in FIG. 4, a user may read or write data in a source cluster 401, and newly written data may be stored in a device of the source cluster 401 through a volume, that is, a storage unit. The method of creating a volume 403 may be designating a device 405, which means that the user designates a device in the source cluster 401 to store data, or it may be in an automatic mode 407, which means that the source cluster 401 automatically selects a device to create a volume.

In some embodiments, the source cluster 401 includes a device cluster 415, the device cluster 415 may include a device 417, a device 419, a device 421, and a device 423, and each device includes 1000 volumes. At a block 409, a remote system is created. Before data synchronization, the source cluster 401 typically creates a remote system. The remote system typically refers to a computer or server located on the other end of a network, which may be accessed by users or applications through the network. The process of creating a remote system may include steps such as installing an operating system, configuring network settings, deploying applications, and setting security policies, which may be specifically selected according to actual needs.

At a block 411, after the remote system is created, a protection policy is created. The protection policy may be formulated by a user or an administrator, and the protection policy may include various types of data protection policies to ensure data integrity, such as data synchronization policy, data encryption policy, or authentication policy.

In some embodiments, an allocation policy 413 may be obtained according to the created protection policy, and the allocation policy is used for providing a target volume allocation strategy to a remote cluster 425. The remote cluster 425 may allocate a volume to a device of the remote cluster 425 according to the allocation policy 413. At a block 427, a replication session is automatically created. The data synchronization process begins, and the remote cluster 524 automatically creates a replication session according to the allocation policy 413. At a block 431, a target volume is created. The replication session is initiated in the source cluster 401, and the remote cluster 425 may use a replication balancer 429 to create the target volume. After the target volume 431 is created, the replication balancer 429 may allocate the target volume to a device in a device cluster 433, and the device cluster 433 may include a device 435, a device 437, a device 439, and a device 441. After the target volume is placed, a block 443 and a block 445 are performed, in which after the creation of the replication session is completed, a replication session is created on the target volume to synchronize the data associated with the replication session in the source end 401.

In the embodiment of the present disclosure, the replication balancer 429 may select, according to the RPO of the replication session initiated in the source cluster 401 and a plurality of parameters of various devices in the remote cluster 425, the target device to place the target volume. After the volumes are placed according to the method of the present disclosure, the numbers of volumes possessed by various devices in the remote cluster 425 are balanced. For example, the device 435 has 923 volumes, the device 437 has 945 volumes, the device 439 has 952 volumes, and the device 441 has 1180 volumes. Compared with 4000 volumes concentrated on the same device, synchronizing data according to the solution of the present disclosure can significantly improve the data synchronization efficiency and device resource utilization.

The above description is the data synchronization solution of the present disclosure. Experimental results implemented according to the solution of the present disclosure will be explained below. In the experiment conducted using the solution of the present disclosure, experimental parameters include: the number of devices being 2, the device capacity watermark being 70%, the device performance headroom being 100, the number of replication sessions being between 100 and 6000, and RPO being set to 0/5/15/30/60 minutes. The indicators measured in the present disclosure include the variance of the numbers of volumes in various devices, the variance of the capacities of the various devices, the variance of performance headroom of the devices, and the variance of the numbers of replication sessions with the same RPO in the various devices. The present disclosure simulates two devices with sufficiently balanced or unbalanced capacities to measure the distribution of replication sessions from 100 to 6000 in a cluster formed by 2 devices.

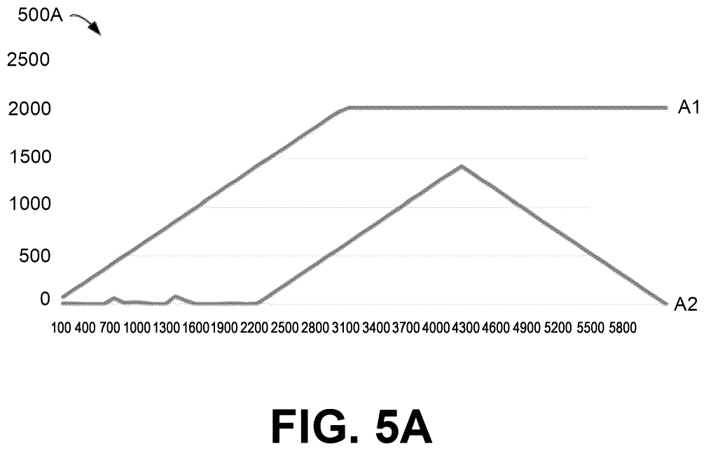

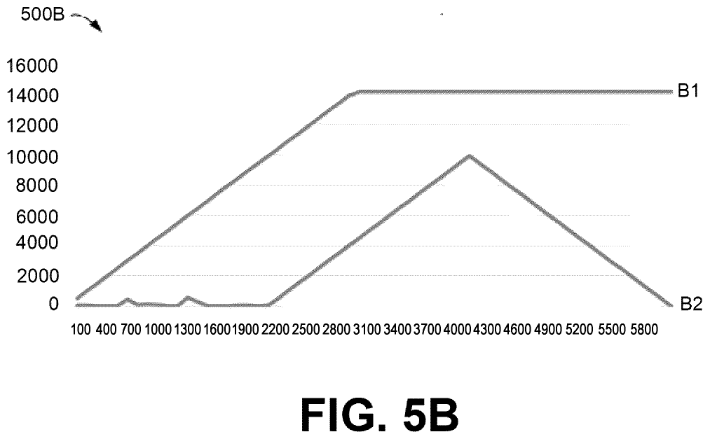

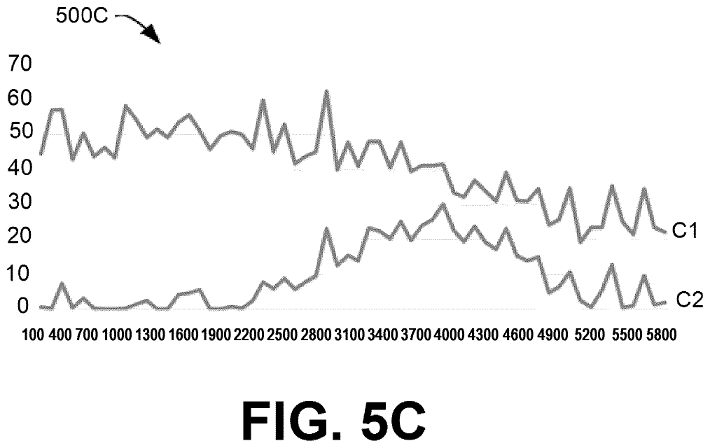

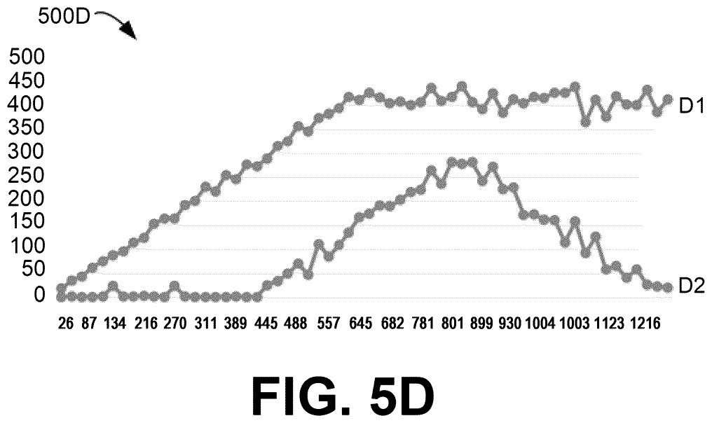

FIG. 5A shows a schematic diagram of a variance 500A of numbers of replication sessions in various devices in a remote cluster according to some embodiments of the present disclosure. In some embodiments, the variance of the numbers of volumes of various devices in the remote cluster may be calculated according to the following formula:

$${variance}_{volume \_ number} = \frac{1}{N - 1} \cdot {\sum }_{i = 1}^{N} {( appliance\_volume {\_number}_{i} - avg\_volume \_number )}^{2} \qquad ( 4 )$$

wherein variance_{volume_number} represents the variance of the numbers of volumes, appliance_volume_numberᵢ represents the number of volumes in the i th device, and avg_volume_number represents the average number of volumes of the various devices.

The average number of volumes avg_volume_number of the various devices may be calculated according to the following formula:

$$vg\_volume \_number = \frac{M}{N} \qquad ( 5 )$$

wherein M represents the total number of volumes in the remote cluster.

As shown in FIG. 5A, A1 represents the variance of the numbers of volumes of various devices obtained by using the solution of related technologies, and A2 represents the variance of the numbers of volumes of various devices obtained by using the solution of the present disclosure. As can be seen from FIG. 5A, the variance of the numbers of volumes of various devices obtained by using the solution of the present disclosure is significantly lower than the variance of the numbers of volumes of various devices obtained by using related technologies, indicating that by using the solution of the present disclosure, the volumes in the remote cluster are evenly distributed among the various devices.

FIG. 5B shows a schematic diagram of a variance 500B of capacities of various devices in a remote cluster according to some embodiments of the present disclosure. In some embodiments, the variance of the capacities of various devices in the remote cluster may be calculated according to the following formula:

$${variance}_{volume \_ capacity} = \frac{1}{N - 1} \cdot {\sum }_{i = 1}^{N} {( appliance\_volume \_total {\_capacity}_{i} - avg\_volume \_capacity )}^{2} \qquad ( 6 )$$

wherein variance_{volume_capacity} represents the variance of the capacities of the various devices, appliance_volume_total_capacityᵢ represents the total capacity of volumes in the ith device, and avg_volume_capacity represents the average capacity of the various devices. The average capacity avg_volume_capacity of the various devices may be calculated according to the following formula:

$$avg\_volume \_capacity = \frac{{\sum }_{i = 1}^{N} {vol\_capacity}_{i}}{M} \qquad ( 7 )$$

wherein vol_capacityᵢ represents the capacity of the ith volume.

As shown in FIG. 5B, B1 represents the variance of the capacities of various devices obtained by using the solution of related technologies, and B2 represents the variance of the capacities of various devices obtained by using the solution of the present disclosure. As can be seen from FIG. 5B, the variance of the capacities of various devices obtained by using the solution of the present disclosure is significantly lower than the variance of the capacities of various devices obtained by using related technologies, indicating that by using the solution of the present disclosure, the used capacities of the various devices in the remote cluster have small differences, and the various devices are evenly utilized during the data synchronization.

FIG. 5C shows a schematic diagram of a variance 500C of performance headroom of various devices in a remote cluster according to some embodiments of the present disclosure. In some embodiments, the variance of the performance headroom of various devices in the remote cluster may be calculated according to the following formula:

$${variance}_{appliance \_ headroom} = \frac{1}{N - 1} \cdot {\sum }_{i = 1}^{N} {( {headroom}_{i} - avg\_headroom )}^{2} \qquad ( 8 )$$

wherein variance_{appliance_headroom} represents the variance of the performance headroom of the various devices, headroomᵢ represents the performance headroom of the i th device, and avg_headroom represents the average performance headroom of the various devices.

As shown in FIG. 5C, C1 represents the variance of the performance headroom of various devices obtained by using the solution of related technologies, and C2 represents the variance of the performance headroom of various devices obtained by using the solution of the present disclosure. As can be seen from FIG. 5C, the variance of the performance headroom of various devices obtained by using the solution of the present disclosure is significantly lower than the variance of the performance headroom of various devices obtained by using related technologies, indicating that by using the solution of the present disclosure, the performance headroom of the various devices in the remote cluster have small differences, and the various devices are evenly utilized during the data synchronization.

FIG. 5D shows a schematic diagram of a variance 500D of the numbers of replication sessions with the same RPO in various devices in a remote cluster according to some embodiments of the present disclosure. In some embodiments, the variance of the numbers of replication sessions with the same RPO in various devices in the remote cluster may be calculated according to the following formula:

$${variance}_{RPO = T} = \frac{1}{N - 1} \cdot {\sum }_{i = 1}^{N} {( {session\_number}_{i} - avg\_session \_number )}^{2} \qquad ( 9 )$$

wherein variance_{RPO=T} represents the variance of the numbers of replication sessions with the RPO of T in the various devices, session_numberᵢ represents the number of replication sessions with the RPO of T in the ith device, and avg_session_number represents the average number of replication sessions with the RPO of T of the various devices.

As shown in FIG. 5D, D1 represents the variance of the numbers of replication sessions with the same RPO in various devices obtained by using the solution of related technologies, and D2 represents the variance of the numbers of replication sessions with the same RPO in various devices obtained by using the solution of the present disclosure. As can be seen from FIG. 5D, the variance of the numbers of replication sessions with the same RPO in various devices obtained by using the solution of the present disclosure is significantly lower than the variance of the numbers of replication sessions with the same RPO in various devices obtained by using related technologies, indicating that by using the solution of the present disclosure, the replication sessions with the same RPO are distributed to different devices.

FIG. 5A to FIG. 5D show the experimental effects of some embodiments of the present disclosure. By comparing the experimental results, it can be concluded that when two devices have balanced capacities, the total numbers of replication sessions on both devices are equal and the replication sessions are evenly distributed, and even for different synchronous/asynchronous RPO sessions, the same results are obtained. For two electric appliances with imbalanced capacities, by using the solution of the present disclosure, replication sessions are evenly distributed across the 2 devices, which is significantly better than the solution of related technologies. Although different synchronous/asynchronous/metropolitan RPO sessions have the same results, the differences in the total number of sessions, capacity, performance headroom, and various types of RPO in the solution of the present disclosure are significantly reduced. The final result shows that the variances of the numbers of volumes, capacities, remaining capacity usages, and RPO types between the two devices in the remote cluster are almost zero, indicating that resource allocation between the devices is balanced.

In order to further demonstrate the beneficial effects of some embodiments of the present disclosure, another experimental solution and its results will be explained below. Testing premises are shown in Table 1:

TABLE 1
Premise

| | | Device | Volume | |
|---|---|---|---|---|
| Cluster | Device | capacity | distribution | Volume capacity |
| Source | A1 | 15.8 T | 1000 | Each volume |
| cluster A | WK-D0470 | | | being 5 GB |
| | A2 | 15.8 T | 1000 | Each volume |
| | WK-D0456 | | | being 5 GB |
| Remote | A1 | 63.5 T | N/A | N/A |
| cluster B | WK-D0523 | | | |
| | A2 | 15.8 T | N/A | N/A |
| | WK-D0532 | | | |

Under the premise of replication without failover and the RPO being 15 minutes, 2000 replication sessions run in 2 application clusters when remote cluster devices have different capacities. A load of 200K IOPS (input/output operations per second) is continuously performed on an IO host of a source cluster A for 2 hours, and results on replication distribution, data transmission rate, and the number of lost RPOs are provided for the solution in related technologies and the solution of the present disclosure in a remote cluster B. Testing results are shown in Table 2:

TABLE 2
The RPO is 15 minutes, and 2000 replication sessions run in 2 application clusters

| | | | | | | Number |
|---|---|---|---|---|---|---|
| | | | | | | of ones |
| | | | | | | that |
| | | | Device | Volume | Transmission | miss |
| Cluster | | Device | capacity | distribution | rate | RPO |
| Related | Remote | A1 | 63.5 T | 2000 | Higher than | 1129 |
| technologies | cluster | WK-D0523 | | | A2 | |
| | B | A2 | 15.8 T | 0 | Lower than | |
| | | WK-D0532 | | | A1 | |
| Some | Remote | A1 | 63.5 T | 1000 | Similar to | 0 |
| embodiments | cluster | WK-D0523 | | | A2 | |
| of the | B | A2 | 15.8 T | 1000 | Similar to | |
| present | | WK-D0532 | | | A1 | |
| disclosure | | | | | | |

As can be seen from Table 2, there is a significant issue of imbalanced data transmission rates in the solution of related technologies. Data transmission is mainly concentrated on the device A1, while the device A2 is in a relatively idle state with the smallest data traffic. This imbalance not only affects the overall data processing efficiency, but also leads to the problem that the number of lost RPOs is up to 1129. However, the present disclosure successfully implements a uniform distribution of replication sessions between remote cluster devices, with almost identical data transmission rates between the devices A1 and A2, demonstrating a balance in the data transmission rates between the devices. More importantly, the present disclosure effectively reduces the number of lost RPOs to 0, thereby significantly improving the stability and reliability of the system.

Taking a set of specific testing scenarios as an example, when a 200K IOPS load is continuously executed on the IO host of the remote cluster B for 2 hours, it can be seen that there are significant differences between the solution of related technologies and the solution of the present disclosure in terms of replication distribution, data transmission rate, instantaneous maximum running command of the cluster, IOPS, and the number of lost RPOs. Especially in the situation where the RPO is 15 minutes, when 2000 replication sessions run in 2 device clusters with different capacities, although all replication sessions complete a failover and the remote cluster B successfully switches roles to the source cluster A, the solution of the present disclosure is superior to the existing technical solution in all aspects, and particularly, a significant effect is achieved in reducing the number of lost RPOs.

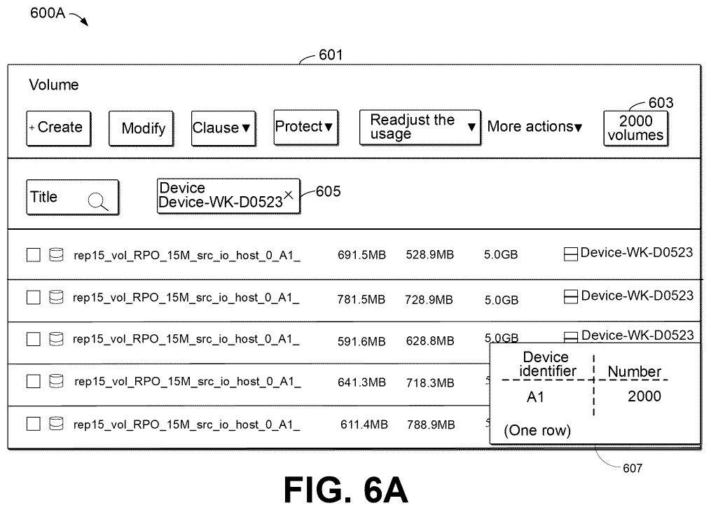

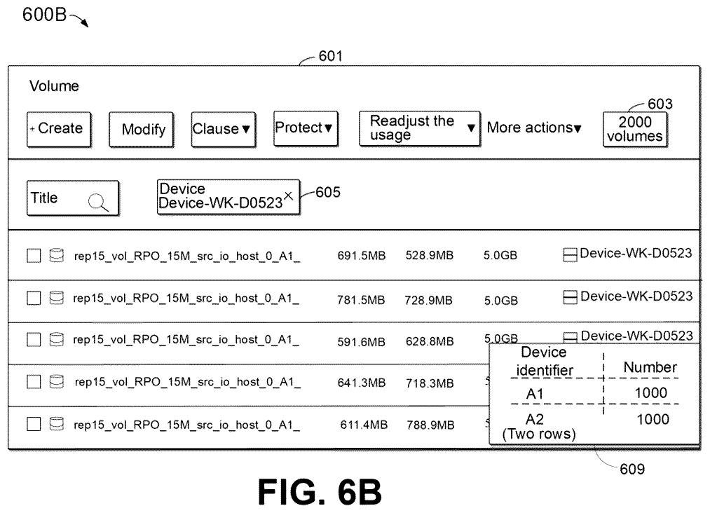

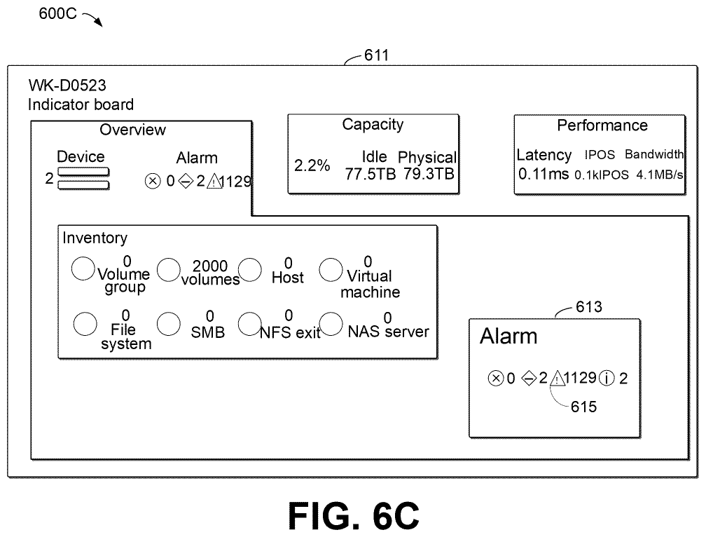

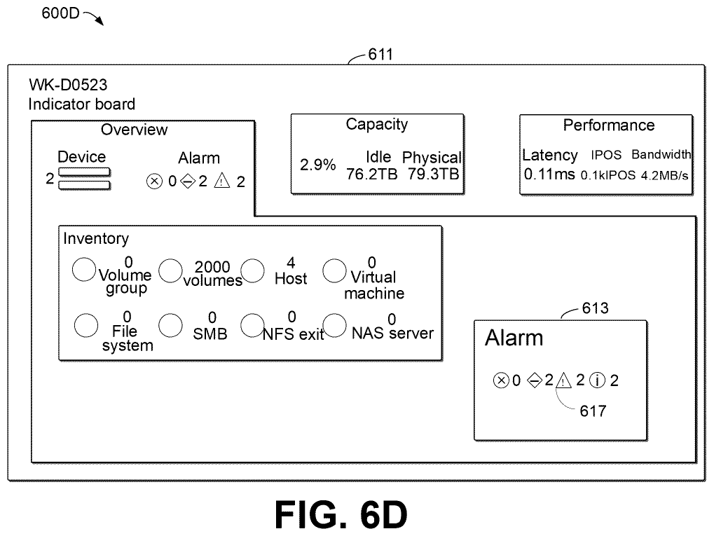

FIG. 6A shows a schematic diagram of a graphical user interface for distribution 600A of the numbers of volumes in various devices of a remote cluster in related technologies. As shown in FIG. 6A, a device may be searched for on a volume distribution display interface 601, and by entering a device model WK-D0523 605, a volume count display box 607 may be obtained. As can be seen from FIG. 6A, under the premise of replication without failover and RPO being 15 minutes, using the solution of related technologies, 2000 replication sessions are concentrated and run on a device A1.

FIG. 6B shows a schematic diagram of a graphical user interface for distribution 600B of the numbers of volumes in various devices of a remote cluster according to some embodiments of the present disclosure. As shown in FIG. 6B, a device may be searched for on a volume distribution display interface 601, and by entering a device model WK-D0523 605, a volume count display box 609 may be obtained. As can be seen from FIG. 6B, under the premise of replication without failover and RPO being 15 minutes and by using the solution of the present disclosure, 2000 replication sessions are uniformly distributed and run on a device A1 and a device A2. Compared with the solution of related technologies, the solution of the present disclosure can evenly distribute replication sessions across various devices, thereby improving the efficiency of data synchronization.

FIG. 6C shows an interface diagram of a graphical user interface for the number 600C of replication sessions that miss RPO in a data synchronization process in related technologies. As shown in FIG. 6C, a display interface 611 may display the number of replication sessions that miss RPO, and the number of replication sessions that miss RPO may be determined by an alarm indicator 615 in an alarm display board 613. As can be seen from FIG. 6C, under the premise of replication without failover and RPO being 15 minutes and by using the solution of related technologies, the number of replication sessions that miss is 1129.

FIG. 6D shows an interface diagram of a graphical user interface for the number 600D of replication sessions that miss RPO in a data synchronization process according to some embodiments of the present disclosure. As shown in FIG. 6D, a display interface 611 may display the number of replication sessions that miss RPO, and the number of replication sessions that miss RPO may be determined by an alarm indicator 615 in an alarm display board 613. As can be seen from FIG. 6D, under the premise of replication without failover and RPO being 15 minutes and by using the solution of the present disclosure, the number of replication sessions that miss is 0. Compared with the solution of related technologies, the solution of the present disclosure can greatly reduce the number of replication sessions that miss RPO, thereby ensuring the data security and integrity and improving the user experience.

Under the condition of replication with failover and RPO being 15 minutes, 2000 replication sessions run in two device clusters with different capacities, and test results are shown in Table 3:

TABLE 3
The RPO is 15 minutes, and 2000 replication sessions run in 2 application clusters

| | | | | | | | Number | |
|---|---|---|---|---|---|---|---|---|
| | | | | | | | of | |
| | | | | | | | ones | |
| | | | | | | | that | Cluster |
| | | | Device | Volume | Transmission | Device | miss | running |
| Cluster | | Device | capacity | distribution | rate | IPOS | RPO | command |
| Related | Remote | A1 | 63.5 T | 2000 | Higher than | 110IPOS | 1629 | 508 |
| technologies | cluster | WK- | | | A2 | | | |
| | B | D0523 | | | | | | |
| | | A2 | 15.8 T | 0 | Lower than | 0IPOS | | |
| | | WK- | | | A1 | | | |
| | | D0532 | | | | | | |
| The | Remote | A1 | 63.5 T | 1000 | Similar to | 102.5kIPOS | 0 | 1400 |
| present | cluster | WK- | | | A2 | | | |
| disclosure | B | D0523 | | | | | | |
| | | A2 | 15.8 T | 1000 | Similar to | 101.5kIPOS | | |
| | | WK- | | | A1 | | | |
| | | D0532 | | | | | | |

As shown in Table 3, all replication sessions have successfully completed the failover, and the cluster B has successfully switched roles to the replication source. In order to evaluate the performance of the solution of related technologies and the solution of the present disclosure, a 200K IOPS load is continuously executed on an IO (input/output) host of the cluster B for 2 hours. In the solution of related technologies, the data transmission rate is obviously concentrated on a device A1, while a device A2 is almost idle, which leads to imbalanced data processing. In contrast, the solution of the present disclosure achieves a uniform distribution of data transmission rates between the devices A1 and A2, thereby significantly improving the balance of data transmission rates between the devices.

As shown in Table 3 above, the instantaneous maximum running command of the cluster in the solution of related technologies is 508, while in the solution of the present disclosure, this number has been increased to 1400, which significantly enhances the capability of the cluster for processing tasks simultaneously. In terms of IO performance, the solution of related technologies may only achieve a maximum total IOPS of 110K due to all target volumes being concentrated on the device A1. However, in the solution of the present disclosure, due to the uniform distribution of target volumes between the devices A1 and A2, the IOPS of the cluster B can reach 204K, with each device contributing approximately 100K IOPS, which significantly improves the overall performance of the cluster. The number of lost RPOs in the solution of related technologies is as high as 1699, while the solution of the present disclosure has successfully reduced this number to 0, which greatly improves the reliability of data protection and provides clients with more powerful disaster recovery capabilities.

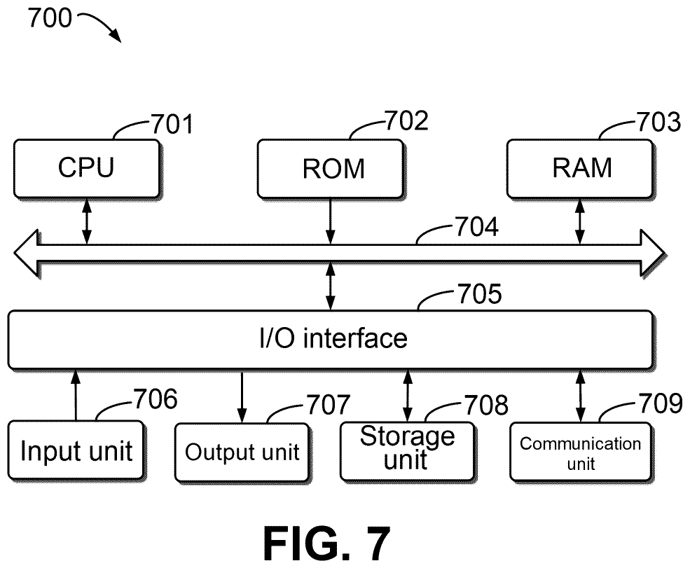

FIG. 7 shows a schematic block diagram of an example device 700 which can be used to implement embodiments of the present disclosure. As shown in the figure, the device 700 includes a computing unit 701 that can perform various appropriate actions and processing according to computer program instructions stored in a read-only memory (ROM) 702 or computer program instructions loaded from a storage unit 708 to a random access memory (RAM) 703. Various programs and data required for the operation of the device 700 may also be stored in the RAM 703. The computing unit 701, the ROM 702, and the RAM 703 are connected to each other via a bus 704. An Input/Output (I/O) interface 705 is also connected to the bus 704.

Multiple components in the device 700 are connected to the I/O interface 705, including: an input unit 706, such as a keyboard and a mouse; an output unit 707, such as various types of displays and speakers; the storage unit 708, such as a magnetic disk and an optical disc; and a communication unit 709, such as a network card, a modem, and a wireless communication transceiver. The communication unit 709 allows the device 700 to exchange information/data with other devices via a computer network, such as the Internet, and/or various telecommunication networks.

The computing unit 701 may be various general-purpose and/or special-purpose processing components with processing and computing powers. Some examples of the computing unit 701 include, but are not limited to, central processing units (CPUs), graphics processing units (GPUs), various specialized artificial intelligence (AI) computing chips, various computing units for running machine learning model algorithms, digital signal processors (DSPs), and any appropriate processors, controllers, microcontrollers, etc. The computing unit 701 performs various methods and processes described above, such as the method 200. For example, in some embodiments, the method 200 may be implemented as a computer software program that is tangibly included in a machine readable medium, such as the storage unit 708. In some embodiments, part or all of the computer program may be loaded and/or installed onto the device 700 via the ROM 702 and/or the communication unit 709. When the computer program is loaded to the RAM 703 and executed by the computing unit 701, one or more steps of the method 200 described above may be performed. Alternatively, in other embodiments, the computing unit 701 may be configured to implement the method 200 in any other suitable manners (such as by means of firmware).

The functions described hereinabove may be executed at least in part by one or more hardware logic components. For example, without limitation, example types of hardware logic components that can be used include: a field programmable gate array (FPGA), an application specific integrated circuit (ASIC), an application specific standard product (ASSP), a system on chip (SOC), a load programmable logic device (CPLD), and the like.

Program codes for implementing the method of the present disclosure may be written by using one programming language or any combination of multiple programming languages. The program code may be provided to a processor or controller of a general purpose computer, a special purpose computer, or another programmable data processing apparatus, such that the program code, when executed by the processor or controller, implements the functions/operations specified in the flow charts and/or block diagrams. The program code may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combinations thereof. Additionally, although operations are depicted in a particular order, this should be understood that such operations are required to be performed in the particular order shown or in a sequential order, or that all illustrated operations should be performed to achieve desirable results. Under certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. Conversely, various features that are described in the context of a single implementation may also be implemented in a plurality of implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the particular features and actions described above are merely example forms of implementing the claims.

1. A method for synchronizing data, comprising:
determining, in response to that a replication session in a source cluster is initiated, a recovery point objective of the replication session and a plurality of parameters of each device in a plurality of devices in a remote cluster, the plurality of parameters comprising at least performance headroom and a recovery point objective of a resident replication session;
selecting a target device from the plurality of devices based on the recovery point objective of the replication session and the plurality of parameters; and
synchronizing data associated with the replication session from the source cluster to the target device in the remote cluster.

2. The method according to claim 1, wherein the plurality of parameters further comprise the capacity utilization, number of resident storage units for storing data, and idle capacity of each device in the remote cluster.

3. The method according to claim 2, wherein selecting the target device from the plurality of devices comprises:
determining a first score for each device based on the capacity utilization of each device and a preset value; and
selecting the target device from the plurality of devices based on the first score.

4. The method according to claim 3, wherein selecting the target device from the plurality of devices further comprises:
determining, based on the number of resident storage units of each device, a second score for each device, wherein in a case that the number of resident storage units of a first device is greater than the number of resident storage units of a second device, the second score for the first device is less than the second score for the second device; and
selecting the target device from the plurality of devices based on the first score and the second score.

5. The method according to claim 4, wherein selecting the target device from the plurality of devices further comprises:
determining, based on the idle capacity of each device, a third score for each device, wherein in a case that the idle capacity of the first device is greater than the idle capacity of the second device, the third score for the first device is greater than the third score for the second device; and
selecting the target device from the plurality of devices based on the first score, the second score, and the third score.

6. The method according to claim 5, wherein selecting the target device from the plurality of devices further comprises:
determining, based on the performance headroom of each device, a fourth score for each device, wherein in a case that the performance headroom of the first device is greater than the performance headroom of the second device, the fourth score for the first device is greater than the fourth score for the second device; and
selecting the target device from the plurality of devices based on the first score, the second score, the third score, and the fourth score.

7. The method according to claim 6, wherein selecting the target device from the plurality of devices further comprises:
determining, based on the recovery point objective of the replication session in the source cluster and the recovery point objective of each replication session in each device, a fifth score for each device, wherein in a case that a first number is greater than a second number, the fifth score for the first device is less than the fifth score for the second device, the first number is the number of resident replication sessions in the first device with the same recovery point objective as the replication session, and the second number is the number of resident replication sessions in the second device with the same recovery point objective as the replication session; and
selecting the target device from the plurality of devices based on the first score, the second score, the third score, the fourth score, and the fifth score.

8. The method according to claim 1, wherein selecting the target device from the plurality of devices comprises:
determining a score for each device based on the recovery point objective of the replication session and the plurality of parameters; and
selecting the target device from the plurality of devices based on the score for each device.

9. The method according to claim 8, wherein selecting the target device from the plurality of devices further comprises:
determining whether a first number is greater than a second number in response to that scores of a first device and a second device are the same, wherein the first number is the number of resident replication sessions in the first device with the same recovery point objective as the replication session, and the second number is the number of resident replication sessions in the second device with the same recovery point objective as the replication session; and
selecting the second device as the target device in response to the first number being greater than the second number.

10. The method according to claim 9, wherein selecting the target device from the plurality of devices further comprises:
determining whether the idle capacity of the first device is greater than the idle capacity of the second device in response to the scores of the first device and the second device being the same and the first number being the same as the second number; and
selecting the first device as the target device in response to that the idle capacity of the first device is greater than the idle capacity of the second device.

11. An electronic device, comprising:
at least one processor; and
coupled to the at least one processor and having instructions stored thereon, wherein the instructions, when executed by the at least one processor, cause the electronic device to perform actions which include:
determining, in response to that a replication session in a source cluster is initiated, a recovery point objective of the replication session and a plurality of parameters of each device in a plurality of devices in a remote cluster, the plurality of parameters comprising at least performance headroom and a recovery point objective of a resident replication session;
selecting a target device from the plurality of devices based on the recovery point objective of the replication session and the plurality of parameters; and
synchronizing data associated with the replication session from the source cluster to the target device in the remote cluster.

12. The device according to claim 11, wherein the plurality of parameters further comprise the capacity utilization, number of resident storage units for storing data, and idle capacity of each device in the remote cluster.

13. The device according to claim 12, wherein the instruction for selecting the target device from the plurality of devices comprises instructions for the following:
determining a first score for each device based on the capacity utilization of each device and a preset value; and
selecting the target device from the plurality of devices based on the first score.

14. The device according to claim 13, wherein the instruction for selecting the target device from the plurality of devices further comprises instructions for the following:
determining, based on the number of resident storage units of each device, a second score for each device, wherein in a case that the number of resident storage units of a first device is greater than the number of resident storage units of a second device, the second score for the first device is less than the second score for the second device; and
selecting the target device from the plurality of devices based on the first score and the second score.

15. The device according to claim 14, wherein the instruction for selecting the target device from the plurality of devices further comprises instructions for the following:
determining, based on the idle capacity of each device, a third score for each device, wherein in a case that the idle capacity of the first device is greater than the idle capacity of the second device, the third score for the first device is greater than the third score for the second device; and
selecting the target device from the plurality of devices based on the first score, the second score, and the third score.

16. The device according to claim 15, wherein the instruction for selecting the target device from the plurality of devices further comprises instructions for the following:
determining, based on the performance headroom of each device, a fourth score for each device, wherein in a case that the performance headroom of the first device is greater than the performance headroom of the second device, the fourth score for the first device is greater than the fourth score for the second device; and
selecting the target device from the plurality of devices based on the first score, the second score, the third score, and the fourth score.

17. The device according to claim 16, wherein the instruction for selecting the target device from the plurality of devices further comprises instructions for the following:
determining, based on the recovery point objective of the replication session in the source cluster and the recovery point objective of each replication session in each device, a fifth score for each device, wherein in a case that a first number is greater than a second number, the fifth score for the first device is less than the fifth score for the second device, the first number is the number of resident replication sessions in the first device with the same recovery point objective as the replication session, and the second number is the number of resident replication sessions in the second device with the same recovery point objective as the replication session; and
selecting the target device from the plurality of devices based on the first score, the second score, the third score, the fourth score, and the fifth score.

18. The device according to claim 11, wherein the instruction for selecting the target device from the plurality of devices comprises instructions for the following:
determining a score for each device based on the recovery point objective of the replication session and the plurality of parameters; and
selecting the target device from the plurality of devices based on the score for each device.

19. The device according to claim 18, wherein the instruction for selecting the target device from the plurality of devices further comprises instructions for the following:
determining whether a first number is greater than a second number in response to that scores of a first device and a second device are the same, wherein the first number is the number of resident replication sessions in the first device with the same recovery point objective as the replication session, and the second number is the number of resident replication sessions in the second device with the same recovery point objective as the replication session; and
selecting the second device as the target device in response to the first number being greater than the second number.

20. A computer program product having a non-transitory computer readable medium which stores a set of instructions to synchronize data; the set of instructions, when carried out by computerized circuitry, causing the computerized circuitry to perform a method of:
determining, in response to that a replication session in a source cluster is initiated, a recovery point objective of the replication session and a plurality of parameters of each device in a plurality of devices in a remote cluster, the plurality of parameters comprising at least performance headroom and a recovery point objective of a resident replication session;
selecting a target device from the plurality of devices based on the recovery point objective of the replication session and the plurality of parameters; and
synchronizing data associated with the replication session from the source cluster to the target device in the remote cluster.
